(19) United States
(12) Patent Application Publication
(10) Pub. No.: US 2004/0176523 A1
(43) Pub. Date: Sep. 9, 2004

(54) Amide polymer material

(76) Inventors: Robert Weiss, Kirchheim (DE); Rainer Neuberg, Dannstadt-Schauernheim (DE); Axel Wilms, Weisenheim (DE); Rainer Klostermann, Hockenheim (DE); Konrad Richter, Ludwigshafen (DE)

Correspondence Address: KEIL & WEINKAUF, 1350 CONNECTICUT AVENUE, N.W., WASHINGTON, DC, 20036, US

(21) Appl. No.: 10/477,354

(22) PCT Filed: May 17, 2002
(86) PCT No.: PCT/EP02/05475

(30) Foreign Application Priority Data
May 22, 2001 (DE) 101 25 137.8

(51) Int. Cl. C08K 3/22

(52) U.S. Cl. 524/497

(57) ABSTRACT

Polymeric material (I) comprising

a) a polymer (II) having amide groups recurring in the polymer main chain and

b) from 0.01 to 5% by weight, based on this polymer, of a titanium dioxide (III) having a median particle size d₅₀ of up to 150 nm,

and fibers, sheet materials and moldings comprising such a polymeric material.

The present invention relates to a polymeric material (I) comprising

a) a polymer (II) having amide groups recurring in the polymer main chain and

b) from 0.01 to 5% by weight, based on this polymer, of a titanium dioxide (III) having a median particle size d₅₀ of up to 150 nm,

and also fibers, sheet materials and moldings comprising such a polymeric material.

The use of polyamides for producing fibers and yarns is common knowledge, for example from Ullmann's Encyclopedia of Industrial Chemistry, 5th Ed., Vol. A10, VCH Verlagsgesellschaft mbH, Weinheim, Germany, 1987, pages 567-579.

Yarn is produced in a conventional manner by melting the polyamide, spinning the polyamide into a fiber, stretching and texturing this fiber with or without an aftertreatment of the fiber.

In the case of carpet fiber, this may be followed by cabling and heat setting of the yarn. Setting processes are known per se. An essential step of a setting process is to direct the yarn through a conditioning chamber under defined process conditions, such as yarn residence time and also elevated temperature in the range from 170 to 200° C. and relative humidity of the atmosphere in the conditioning chamber.

In the case of textile fiber, this is often heat set on a tenter before dyeing after processing into fabrics. This heat setting serves to enhance the dimensional stability of the fabric in the course of the subsequent dyeing and further processing and to control edge curl. Fabrics are exposed to a temperature of from 170 to 200° C. in the course of heat setting.

The disadvantage of these heat setting operations is that polyamide quality, as evidenced by a reduction in the viscosity or in the amino end group (“AEG”) content, deteriorates substantially in the course of this setting. The reduced AEG is evidence of polymer damage. For example, when the polymer is to be dyed, especially in the form of a fabric, the reduced AEG leads to a reduced depth of dyeing and a reduced uniformity of dyeing, for example to barriness.

To reduce this damage, it is known to physically admix the polymer with stabilizers. This has the disadvantage that the stabilizers may wash off or evaporate out of the polymer again in the course of heat setting, dyeing or later use of the products produced from the polymers.

To solve this problem, it has been proposed in WO 95/28443, DE-A-195 37 614, WO 97/05189 and U.S. Pat. No. 5,851,238 for example to chemically bond a stabilizer, especially a sterically hindered piperidine derivative, to the polymer main chain.

Despite this disclosure, there is a need for a further improvement in the stabilization of polyamides.

It is an object of the present invention to provide a polymeric material from which it is possible to produce fibers, sheet materials and moldings having improved heat stabilization, as measured by a reduced reduction in the viscosity, the amino end group (AEG) content, the depth of dyeing and the uniformity of dyeing.

We have found that this object is achieved by the polymeric materials defined at the beginning and by fibers, sheet materials and moldings comprising such polymeric materials.

According to the invention, the polymeric material (I) comprises a polymer (II) having amide groups recurring in the polymer main chain.

For the purposes of the present invention, a polymer (II) is a polymer having amide groups recurring in the polymer main chain or a mixture of various polymers having amide groups recurring in the polymer main chain.

As well as polymer (II), the polymeric material (I) may comprise further polymers which are not polymers (II). In an advantageous embodiment, the polymer in polymeric material (I) is exclusively polymer (II).

In a particularly preferred embodiment, the polymeric material (I) contains as polymer (II) exclusively a polymer having amide groups recurring in the polymer main chain.

In another particularly preferred embodiment, the polymeric material (I) contains as polymer (II) a mixture of plural, such as 2, 3, 4 or 5, polymers having amide groups recurring in the polymer main chain. Such polymers (II) may also contain more than 5 polymers having amide groups recurring in the polymer main chain. But it has hitherto proved economically more advantageous to limit the number in polymer (II) of polymers having amide groups recurring in the polymer main chain; more particularly, 2 or 3 have proved particularly advantageous.

Polymer (II), as well as amide groups recurring in the polymer main chain, may contain other functional groups, especially such functional groups and to such an extent that the effect of the present invention is not adversely affected. Advantageous other functional groups include ether, amino, keto, sulfide, sulfone, imide, ester, carbonate or urethane groups, especially ethers and esters.

In an advantageous embodiment, the polymer main chain of polymer (II) contains no functional groups other than the amide group.

Polymers having amide groups recurring in the polymer main chain are customarily known as polyamides.

Polyamides are herein to be understood as being homopolymers, copolymers, blends and grafts of synthetic long-chain polyamides having recurring amide groups in the polymer main chain as an essential constituent. Examples of such polyamides are nylon 6 (polycaprolactam), nylon 6,6 (polyhexamethyleneadipamide), nylon 4,6 (polytetramethyleneadipamide), nylon 6,10 (polyhexamethylene -sebacamide), nylon 6,12 (polyhexamethylene-1,10-decanedicarboxamide), nylon 7 (polyenantholactam), nylon 11 (polyundecanolactam), nylon 12 (polydodecanolactam). As well as polyamides known by the generic name of nylon, polyamides further include the aramids (aromatic polyamides), such as poly-meta-phenyleneisophthalamide (NOMEX® fiber, U.S. Pat. No. 3,287,324) or poly-para-phenyleneterephthalamide (KEVLAR® fiber, U.S. Pat. No. 3,671,542).

Polyamides can in principle be prepared by two methods.

In a polymerization from dicarboxylic acids and diamines and also in a polymerization from amino acids or their derivatives, such as aminocarbonitriles, aminocarboxamides, aminocarboxylate esters or aminocarboxylate salts, the amino and carboxyl end groups of the starting monomers or starting oligomers react with one another to form an amide group and water. The water can subsequently be removed from the polymer. In a polymerization from carboxamides, the amino and amide end groups of the starting monomers or starting oligomers react with one another to form an amide group and ammonia. The ammonia can subsequently be removed from the polymer. This polymerization reaction is customarily known as a polycondensation.

A polymerization from lactams as starting monomers or starting oligomers is customarily known as a polyaddition.

Polymers having amide groups recurring in the polymer main chain can be prepared using monomers selected from the group consisting of lactams, omega-aminocarboxylic acids, omega-aminocarbonitriles, omega-aminocarboxamides, omega-aminocarboxylate salts, omega-aminocarboxylate esters, equimolar mixtures of diamines and dicarboxylic acids, dicarboxylic acid/diamine salts, dinitriles and diamines or mixtures thereof.

Useful Monomers Include

monomers or oligomers of a C₂ to C₂₀, preferably C₂ to C₁₈, arylaliphatic or, preferably, aliphatic lactam such as enantholactam, undecanolactam, dodecanolactam or caprolactam,

monomers or oligomers of C₂ to C₂₀, preferably C₃ to C₁₈, aminocarboxylic acids such as 6-aminocaproic acid or 11-aminoundecanoic acid, and dimers, trimers, tetramers, pentamers or hexamers thereof, and salts thereof such as alkali metal salts, for example lithium, sodium or potassium salts,

C₂ to C₂₀, preferably C₃ to C₁₈, aminocarboxylic acid nitriles such as 6-aminocapronitrile or 11-aminoundecanoic acid nitrile,

monomers or oligomers of C₂ to C₂₀ amino acid amides such as 6-aminocapramide or 11-aminoundecanamide, and dimers, trimers, tetramers, pentamers or hexamers thereof,

esters, preferably C₁-C₄ alkyl esters, such as methyl, ethyl, n-propyl, i-propyl, n-butyl, i-butyl or s-butyl esters, of C₂ to C₂₀, preferably C₃ to C₁₈, aminocarboxylic acids, such as 6-aminocaproic acid esters, for example methyl 6-aminocaproate, or 11-aminoundecanoic acid esters, for example methyl 11-aminoundecanoate,

monomers or oligomers of a C₂ to C₂₀, preferably C₂ to C₁₂, alkyldiamine, such as tetramethylenediamine or, preferably, hexamethylenediamine,

with a C₂ to C₂₀, preferably C₂ to C₁₄, aliphatic dicarboxylic acid or mono- or dinitriles thereof, such as sebacic acid, dodecanedioic acid, adipic acid, sebacic acid dinitrile, decanoic acid dinitrile or adiponitrile,

and dimers, trimers, tetramers, pentamers or hexamers thereof,

monomers or oligomers of a C₂ to C₂₀, preferably C₂ to C₁₂, alkyldiamine, such as tetramethylenediamine or, preferably, hexamethylenediamine,

with a C₈ to C₂₀, preferably C₈ to C₁₂, aromatic dicarboxylic acid or derivatives thereof, for example chlorides, such as naphthalene-2,6-dicarboxylic acid, preferably isophthalic acid or terephthalic acid, and dimers, trimers, tetramers, pentamers or hexamers thereof,

monomers or oligomers of a C₂ to C₂₀, preferably C₂ to C₁₂, alkyldiamine, such as tetramethylenediamine or, preferably, hexamethylenediamine,

with a C₉ to C₂₀, preferably C₉ to C₁₈, arylaliphatic dicarboxylic acid or derivatives thereof, for example chlorides, such as o-, m- or p-phenylenediacetic acid,

and dimers, trimers, tetramers, pentamers or hexamers thereof,

monomers or oligomers of a C₆ to C₂₀, preferably C₆ to C₁₀, aromatic diamine, such as m- or p-phenylenediamine,

with a C₂ to C₂₀, preferably C₂ to C₁₄, aliphatic dicarboxylic acid or mono- or dinitriles thereof, such as sebacic acid, dodecanedioic acid, adipic acid, sebacic acid dinitrile, decanoic acid dinitrile or adiponitrile,

and dimers, trimers, tetramers, pentamers or hexamers thereof,

monomers or oligomers of a C₆ to C₂₀, preferably C₆ to C₁₀, aromatic diamine, such as m- or p-phenylenediamine,

with a C₈ to C₂₀, preferably C₈ to C₁₂, aromatic dicarboxylic acid or derivatives thereof, for example chlorides, such as naphthalene-2,6-dicarboxylic acid, preferably isophthalic acid or terephthalic acid,

and dimers, trimers, tetramers, pentamers or hexamers thereof,

monomers or oligomers of a C₆ to C₂₀, preferably C₆ to C₁₀, aromatic diamine, such as m- or p-phenylenediamine,

with a C₉ to C₂₀, preferably C₉ to C₁₈, arylaliphatic dicarboxylic acid or derivatives thereof, for example chlorides, such as o-, m- or p-phenylenediacetic acid,

and dimers, trimers, tetramers, pentamers or hexamers thereof,

monomers or oligomers of a C₇ to C₂₀, preferably C₈ to C₁₈, arylaliphatic diamine, such as m- or p-xylylenediamine,

with a C₂ to C₂₀, preferably C₂ to C₁₄, aliphatic dicarboxylic acid or mono- or dinitriles thereof, such as sebacic acid, dodecanedioic acid, adipic acid, sebacic acid dinitrile, decanoic acid dinitrile or adiponitrile,

and dimers, trimers, tetramers, pentamers or hexamers thereof,

monomers or oligomers of a C₇ to C₂₀, preferably C₈ to C₁₈, arylaliphatic diamine, such as m- or p-xylylenediamine,

with a C₆ to C₂₀, preferably C₆ to C₁₀, aromatic dicarboxylic acid or derivatives thereof, for example chlorides, such as naphthalene-2,6-dicarboxylic acid, preferably isophthalic acid or terephthalic acid,

and dimers, trimers, tetramers, pentamers or hexamers thereof,

monomers or oligomers of a C₇ to C₂₀, preferably C₈ to C₁₈, arylaliphatic diamine, such as m- or p-xylylenediamine,

with a C₉ to C₂₀, preferably C₉ to C₁₈, arylaliphatic dicarboxylic acid or derivatives thereof, for example chlorides, such as o-, m- or p-phenylenediacetic acid,

and dimers, trimers, tetramers, pentamers or hexamers thereof,

and homopolymers, copolymers, mixtures and grafts of such starting monomers or starting oligomers.

Particular preference is given to those starting monomers or oligomers which on polymerization lead to the polyamides nylon 6, nylon 6,6, nylon 4,6, nylon 6,10, nylon 7, nylon 11 or nylon 12 or the aramids poly-meta-phenyleneisophthalamide or poly-para-phenyleneterephthalamide, especially to nylon 6 (polycaprolactam) and nylon 66 (poly(hexamethylene ammonium adipate)).

In an advantageous embodiment, the preparation of the polymers suitable for forming polymer (II) can be conducted in the presence of a sterically hindered piperidine derivative which has a group capable of amide formation with regard to the polymer main chain of the polymer having amide groups recurring in the polymer main chain, or in the presence of mixtures thereof, although for the purposes of the present invention a single piperidine derivative or mixtures of plural piperidine derivatives are termed a piperidine derivative.

Preferred sterically hindered piperidine derivatives are those of the formula

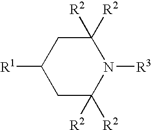

where

R¹ is a functional group capable of amide formation with the polymer main chain of the polymer having amide groups recurring in the polymer main chain,

preferably a group —(NH)R⁵, in which R⁵ is hydrogen or C₁-C₈ alkyl, or a carboxyl group, or a carboxyl derivative, or a group —(CH₂)ₓ(NH)R⁵, in which x is 1 to 6 and R⁵ is hydrogen or C₁-C₈ alkyl, or a group —(CH₂)_{y}COOH, in which y is 1 to 6, or a —(CH₂)_{y}COOH acid derivative, in which y is 1 to 6, especially a group —NH₂,

R² is an alkyl group, preferably a C₁-C₄ alkyl group such as methyl, ethyl, n-propyl, i-propyl, n-butyl, i-butyl or s-butyl,

especially a methyl group,

R³ is hydrogen, C₁-C₄ alkyl or O—R⁴, in which R⁴ is hydrogen or C₁-C₇ alkyl,

R³ being hydrogen in particular.

In such compounds, steric hindrance usually prevents the tertiary amino groups, and especially the secondary amino groups, of the piperidine ring system from reacting.

A particularly preferred sterically hindered piperidine derivative is 4-amino-2,2,6,6-tetramethylpiperidine (“TAD”).

In another particularly preferred embodiment, the sterically hindered piperidine derivative used can be selected from those mentioned in WO 99/48949, especially bis(4-amino-2,2,6,6-tetramethylpiperidino)hexane.

In another particularly preferred embodiment, the sterically hindered piperidine derivative used can be an ester, preferably of a carboxylic acid having one or more, such as 2, 3 or 4, especially 2, carboxylic acid groups, such as isophthalic acid, terephthalic acid, adipic acid, of 4-amino-2,2,6,6-tetramethylpiperidine.

Advantageously, such a piperidine derivative may be used in amounts from at least 0.005 mol %, preferably at least 0.015 mol %, especially at least 0.025 mol %, based on acid amide groups of the polymer.

Advantageously, such a piperidine derivative may be used in amounts of at most 0.6 mol %, preferably at most 0.4 mol %, especially at most 0.25 mol %, based on acid amide groups of the polymer.

This results in amounts of at least 0.017% by weight, preferably at least 0.05% by weight and especially at least 0.08% by weight, based on the total weight of the polymer.

This results in amounts of at most 2.1% by weight, preferably at most 1.4% by weight and especially at most 0.87% by weight, based on the total weight of the polymer.

Advantageously, the polymerization to form polymers having amide groups recurring in the polymer main chain is carried out in the presence of a compound having plural, such as two, three or four, preferably two, amino groups capable of amide formation with regard to the polymer main chain of the polymer, or in the presence of mixtures thereof.

Such compounds include advantageously C₂ to C₂₀ and preferably C₂ to C₁₂ alkyldiamines, such as tetramethylenediamine or preferably hexamethylenediamine, C₆ to C₂₀ and preferably C₆ to C₁₀ aromatic diamines, such as m- or p-phenylenediamine, or C₇ to C₂₀ and preferably C₈ to C₁₈ arylaliphatic diamines, such as m- or p-xylylenediamine, or such compounds as are customarily used as chain regulators in the production of polymers having amide groups recurring in the polymer main chain. Particular preference is given to hexamethylenediamine.

Such compounds may bear substituents, such as halogens, for example fluorine, chlorine or bromine, sulfonic acid groups or salts thereof, such as lithium, sodium or potassium salts, or be unsubstituted.

Such compounds may advantageously be used in amounts of at least 0.01% by weight, preferably at least 0.05% by weight and especially at least 0.2% by weight, based on the total weight of polymer (II).

Such compounds may advantageously be used in amounts of at most 0.5% by weight, preferably at most 0.35% by weight and especially at most 0.25% by weight, based on the total weight of polymer (II).

The polymerization may advantageously be conducted in the presence or absence of a compound having an amino group capable of amide formation with regard to the polymer main chain, or in the presence of mixtures.

Such compounds may advantageously be C₂ to C₂₀ and preferably C₂ to C₁₂ alkylamines, such as cyclohexylamine, C₆ to C₂₀ and preferably C₆ to C₁₀ aromatic monoamines, such as aniline, or C₇ to C₂₀ and preferably C₈ to C₁₋₈ arylaliphatic monoamines, such as benzylamine, or such compounds as are customarily used as chain regulators in the production of polymers having amide groups recurring in the polymer main chain.

Such compounds may bear substituents, such as halogens, for example fluorine, chlorine or bromine, sulfonic acid groups or salts thereof, such as lithium, sodium or potassium groups, or be unsubstituted.

Such compounds may advantageously be used in amounts of at least 0.01% by weight, preferably at least 0.05% by weight and especially at least 0.2% by weight, based on the total weight of polymer (II).

Such compounds may advantageously be used in amounts of at most 0.5% by weight, preferably at most 0.35% by weight and especially at most 0.25% by weight, based on the total weight of polymer (II).

The polymerization may advantageously be conducted in the presence or absence of a compound having a carboxylic acid group capable of amide formation with regard to the polymer main chain of the polymer having amide groups recurring in the polymer main chain, or in the presence of mixtures.

Such compounds may advantageously be C₂ to C₂₀ and preferably C₂ to C₁₂ carboxylic acids, such as acetic acid, propionic acid, C₇ to C₂₁ and preferably C₇ to C₁₁ aromatic carboxylic acids, such as benzoic acid, or C₈ to C₂₁ and preferably C₉ to C₁₋₉ arylaliphatic carboxylic acids, or such compounds as are customarily used as chain regulators in the production of polymers having amide groups recurring in the polymer main chain.

Such compounds may bear substituents, such as halogens, for example fluorine, chlorine or bromine, sulfonic acid groups or salts thereof, such as lithium, sodium or potassium salts, or be unsubstituted.

Such compounds may advantageously be used in amounts of at least 0.01% by weight, preferably at least 0.05% by weight and especially at least 0.2% by weight, based on the total weight of polymer (II).

Such compounds may advantageously be used in amounts of at most 2% by weight, preferably at most 0.1% by weight and especially at most 0.7% by weight, based on the total weight of polymer (II).

The polymerization can advantageously be conducted in the presence or absence of a compound—different from the monomers having plural, such as two, three or four, preferably two, carboxylic acid groups capable of amide formation with regard to the polymer main chain of the polymer having amide groups recurring in the polymer main chain, or mixtures thereof.

Such compounds may advantageously be C₂ to C₂₀ and preferably C₂ to C₁₂ dicarboxylic acids, such as sebacic acid, dodecanoic acid, cyclohexane-1,4-dicarboxylic acid or preferably adipic acid, C₈ to C₂₂ and preferably C₈ to C₁₂ aromatic dicarboxylic acids, such as benzene- and naphthalenedicarboxylic acids, preferably 2,6-naphthalenedicarboxylic acid, isophthalic acid or terephthalic acid, or C₉ to C₂₂ and preferably C₉ to C₂₀ arylaliphatic dicarboxylic acids or such compounds as are customarily used as chain regulators in the production of polymers having amide groups recurring in the polymer main chain. Particular preference is given to terephthalic acid and isophthalic acid.

Such compounds may bear substituents, such as halogens, for example fluorine, chlorine or bromine, sulfonic acid groups or salts thereof, such as lithium, sodium or potassium salts, or be unsubstituted.

Preference is given to sulfonated dicarboxylic acids, especially sulfoisophthalic acid, or one of its salts, such as alkali metal salts, for example lithium, sodium, potassium salts, preferably lithium or sodium salts, especially lithium salt.

Such compounds may advantageously be used in amounts of at least 0.01% by weight, preferably at least 0.05% by weight and especially at least 0.2% by weight, based on the total weight of polymer (II).

Such compounds may advantageously be used in amounts of at most 2% by weight, preferably at most 0.1% by weight and especially at most 0.7% by weight, based on the total weight of polymer (II).

According to the invention, polymeric material (I) comprises from 0.01 to 5% by weight, based on polymer (II) of a titanium dioxide (III) having a median particle size d₅₀ of up to 150 nm. The titanium dioxide (III) advantageously has a median particle size d₅₀ of up to 120 nm, especially up to 100 nm, particularly preferably up to 90 nm. The titanium dioxide (III) advantageously has a median particle size d₅₀ of at least 10 nm, preferably at least 20 nm, especially at least 30 nm. Herein, the median particle size is the median particle diameter measured in suspension by the ultracentrifuge method (mass distribution). d₅₀ means that 50% of the particles (based on mass) are smaller than the indicated size. The method of measurement is known per se and described for example in DE-A-100 04 461.

The preparation of such finely divided titanium dioxide pigments is known per se, for example from DE-A-100 04 461 or WO 00/14165.

Titanium dioxide (III) may be advantageously used in amounts of at least 0.1% by weight, especially at least 0.2% by weight, based on polymer (II).

Titanium dioxide (III) may be advantageously used in amounts of at most 3% by weight, especially at most 1.8% by weight, based on (II).

In a preferred embodiment, polymer (II) may comprise pigments in addition to the finely divided titanium dioxide (III). Preferred pigments are titanium dioxide, the titanium dioxide being present in the anatase form or rutile form, preferably in the anatase form, in which it is used in polyamides as a delusterant in a conventional manner, or coloring compounds which are inorganic or organic in nature. Such titanium dioxide pigments used as delusterants customarily have a larger median particle size d₅₀ than titanium dioxide (III). They should advantageously have a median particle size d₅₀ of above 200 nm and preferably of above 250 nm. Advantageously, such titanium dioxide pigments used as delusterants should have a median particle size d₅₀ of up to 10 μm. The pigments may preferably be present in polymer (II) in an amount of up to 5 parts by weight, especially up to 2 parts by weight, in either case based on 100 parts by weight of polymer (II). The pigments may preferably be present in polymer (II) in an amount of at least 0.01 part by weight, especially at least 0.02 part by weight, in either case based on 100 parts by weight of polymer (II).

It may be advantageous to add the pigments in the course of the production of the polymer.

It may be preferable to prepare polymers (II) by customary processes.

For instance, the polymerization of caprolactam monomer to prepare nylon 6 may be effected for example according to the continuous or batch processes described in DE-A 14 95 198, DE-A 25 58 480, DE-A 44 13 177, Polymerization Processes, Interscience, New York, 1977, pages 424-467 and Handbuch der Technischen Polymerchemie, VCH Verlagsgesellschaft, Weinheim, 1993, pages 546-554.

It is advantageous to prepare polycaprolactam by adding titanium dioxide (III) as a suspension or as a pigment concentrate in polycaprolactam, preferably at pigment contents in the range from 1 to 90% by weight and particularly preferably in the range from 10 to 50% by weight, especially in the range from 20 to 35% by weight, based on the total weight of the pigment concentrate, to the monomer, i.e., to the caprolactam, or during the polymerization to the oligomer in one or more stages.

The polymerization of 66 salt monomer to prepare nylon 66 can be effected according to the customary batch process (see: Polymerization Processes, Interscience, New York, 1977, pages 424-467, especially 444-446) or according to a continuous process, for example as described in EP-A 129 196.

It is advantageous to prepare poly(hexamethylene diammonium adipate) by adding titanium dioxide (III) as a suspension advantageously in water, preferably at pigment contents in the range from 1 to 90% by weight, particularly preferably in the range from 10 to 50% by weight and especially in the range from 20 to 35% by weight, based on the total weight of the pigment concentrate, in one or more stages, preferably during the precondensation phase. It may be similarly advantageous to add it as a pigment concentrate in monomers suitable for preparing polymer (I) such as caprolactam, in a polymer (I), such as nylon 6 or nylon 66, preferably at pigment contents in the range from 1 to 90% by weight, particularly preferably in the range from 10 to 50% by weight and especially in the range from 20 to 35% by weight, based on the total weight of the pigment concentrate, in one or more stages, preferably during the precondensation phase.

The preparation of the aforementioned pigment concentrates and suspensions containing titanium dioxide (III) is known per se, for example from DE-A-100 04 461 or WO 00/14165.

The polymeric materials (I) according to the invention are very useful for producing filaments, fibers, films, fabrics and moldings. Of particular advantage are filaments obtained from polyamides, especially polycaprolactam, by high speed spinning at spinning speeds of at least 2000 m/min and preferably at least 4000 m/min. The filaments, fibers, films, fabrics and moldings obtained using the polyamides of the invention are useful for many applications, for example as textile clothing or carpet fibers.

### EXAMPLES

The AEG content was determined as an acidometric titration. The amino end groups were titrated with perchloric acid in a 70:30 w/w solution in phenol/methanol.

The relative viscosity of the polymeric materials was determined in 1% solution (1 g/100 ml) in concentrated sulfuric acid (96% by weight) at 25° C. in accordance with DIN 51562-1 to −4 as at January 1999.

The heat stability of the polyamide filaments was determined under conditions which correspond to those of heat setting processes in subsequent treatment stages, for example heat setting of BCF (bulked continuous filament) or tenter setting of textile fabrics. 5 g shanks of the drawn filaments were rapidly introduced on a holder together with the comparative samples into a through circulation oven preheated to 185° C. and left therein for 120 seconds from reattainment of the air temperature measured in direct sample vicinity. The sample was then immediately removed and cooled down in air at 20° C. room temperature. Filaments to be compared were treated together.

The damage incurred (compared with an untreated sample of the same filament) was determined as a change in the relative viscosity (RV) and in the AEG content. A smaller—positive as well as negative—change in the two values indicates less damage.

Depth of dyeing and uniformity of dyeing were evaluated by knitting the yarns to be investigated up into socks, which were heat set and subsequently competitively dyed.

The fabrics were heat set at 185° C. for 120 seconds. The knit was then prewashed with Nekanil LN, Trilon TA and acetic acid and dyed in hot water (98° C.) with a mixture of 2% of Intrazone Red G (190%), 2% of Intracid Rhodamine B, 2% of ammonium sulfate and 1% of Uniperol W at pH 3.5.

A black dyeing was carried out at pH 7 with 1% of Uniperol® AC and 0.3% of Acidol Black MSRL® dye following pretreatment with Kiralon® MFB, Lufibrol® MSD and sodium carbonate.

The depth of shade was then automatically determined using a Color-flash instrument. The change in the depth of shade was determined as follows:

Change in depth of shade=

Depth of shade of inventive example (after heat setting) [%]−Depth of shade of comparative example (after heat setting)

Depth of shade of inventive example (before heat setting) [%]

Depth of shade of comparative example (before heat setting)

The greater the increase in the depth of shade in relation to the comparative example, the better the depth of shade.

Uniformity of dyeing was assessed by inspection. The dyed samples were independently rated by five people on the scale of:

1=not barry to 6=very barry.

The mean value of the assessments is reported.

Preparation of Polymers

a) Batch Preparation of Nylon 6

The starting compounds (caprolactam, water, chain regulator, piperidine derivative, Hombitec S 120 (from Sachtleben Chemie GmbH), pigment concentrate PC1 (from BASF Aktiengesellschaft) were heated to 260° C. in a 360 1 vessel over 2 hours. After depressurization (over 90 min), the batch was supplementarily condensed for 45 minutes and then discharged under a small nitrogen overpressure. The polyamide obtained was subsequently pelletized, extracted with hot water and tumble dried under nitrogen.

b) Batch Preparation of Nylon 66

60% by weight solution of 66 salt, chain regulator, piperidine derivative were precondensed at 160° C. and atmospheric pressure for 15 minutes. This was followed by the addition of titanium dioxide (III) in the form of a 28% by weight aqueous suspension (Hombitec S 120 A from Sachtleben Chemie GmbH) and/or of a customary delustering titanium dioxide in the form of a 30% by weight aqueous suspension. This was followed by full condensation at a pressure of 18 bar and a temperature of 275° C. for 90 minutes, at which point the reactor was depressurized and the polymer discharged under nitrogen and pelletized.

c) Spinning

The polymers were spun on a spinning range at 265° C. (nylon 6) or 295° C. (nylon 66) by the H4S process using a winding speed of 5040 m/min per 44 dtex 12 filament yarn of round cross section. The throughput was 22 g/min per hole. The takeoff speed was 4300 m/min (duo 1), the draw ratio was 1:1.28 (duo 2=5500 m/min) and the yarn tension upstream of the winder was in the range from 3 to 6 cN. The steam box was operated with 3 bar steam.

The properties of the polyamides are summarized below in tables 1 and 2. The weight percentages are each based on total polymer weight.

The polyamides of the invention exhibit a smaller decrease in the relative viscosity and in the AEG content, a higher uniformity of dyeing and a deeper depth of shade especially after heat setting than the comparative polyamides.

TABLE 1
Nylon 66

| | | | TiO2 | | | | | Change in |
|---|---|---|---|---|---|---|---|---|
| | Propionic | TAD | (III) | Standard | Change in | | Change in | depth of |
| | acid | % by | % by | TiO2 | AEG | Dyeing | RV | shade |
| Example | % by weight | weight | weight | % by weight | % | uniformity | % | (red) % |
| 1a | 0.1 | 0 | 0.15 | 0.15 | −35 | 4 | −2 | 14 |
| 1b | 0.1 | 0 | 0.3 | 0 | −25 | 3 | +1 | 8 |
| 1c | 0.1 | 0.3 | 0.15 | 0.15 | −22 | 2 | −1 | 18 |
| 1d | 0.1 | 0.3 | 0.3 | 0 | −20 | 1 | 0 | 9 |
| Comp. 1 | 0.1 | 0 | 0 | 0.3 | −42 | 5 | −14 | ./. |
| 2a | 0.1 | 0 | 0.6 | 0 | −24 | 2 | +4 | 6 |
| 2b | 0.1 | 0 | 0.23 | 0.37 | −22 | 1 | −3 | 10 |
| Comp. 2 | 0.1 | 0 | 0 | 0.6 | −45 | 5 | −17 | ./. |
| 3a | 0.1 | 0 | 0.08 | 1.52 | −40 | 4 | −14 | 2 |
| 3b | 0.1 | 0.15 | 0.8 | 0.8 | −23 | 1 | −1 | 30 |
| Comp. 3 | 0.1 | 0 | 0 | 1.6 | −41 | 5 | −19 | ./. |

TABLE 2
Nylon 6

| | | | TiO₂ | | | | | Change in |
|---|---|---|---|---|---|---|---|---|
| | Terephthalic | TAD | (III) | Standard | Change in | | Change | depth of |
| | acid | % by | % by | TiO2 | AEG | Dyeing | in RV | shade |
| Example | % by weight | weight | weight | % by weight | % | uniformity | % | black) % |
| 1a | 0.6 | 0 | 0.15 | 0.15 | −20 | 2 | −9 | 10 |
| 1b | 0.6 | 0 | 0.3 | 0 | −19 | 3 | −8 | 20 |
| 1c | 0.6 | 0.3 | 0.15 | 0.15 | −10 | 1 | 0 | 30 |
| 1d | 0.6 | 0.3 | 0.3 | 0 | −15 | 3 | −7 | 20 |
| Comp. 1 | 0.6 | 0 | 0 | 0.3 | −25 | 4 | −11 | ./. |
| 2a | 0.4 | 0.2 | 1.6 | 0 | −7 | 2 | 0 | 25 |
| 2b | 0.4 | 0.2 | 0.8 | 0.8 | −5 | 1 | +2 | 35 |
| 2c | 0.4 | 0 | 0.8 | 0.8 | −15 | 3 | −8 | 20 |
| Comp. 2 | 0.4 | 0 | 0 | 1.6 | −20 | 5 | −10 | ./. |
| | Adipic acid | | | | | | | |
| | % by weight | | | | | | | |
| 3 | 0.2 | 0.4 | 0.15 | 0.15 | −8 | 2 | 0 | 15 |
| | Isophthalic | | | | | | | |
| | acid | | | | | | | |
| | % by weight | | | | | | | |
| 4 | 0.3 | 0.4 | 0.6 | 0.6 | −5 | 3 | −10 | 17 |
| | Lithium | | | | | | | |
| | sulfo- | | | | | | | |
| | isophthalate | | | | | | | |
| | % by weight | | | | | | | |
| 5 | 0.1 | 0.2 | 0.3 | 0.3 | −16 | 3 | −10 | 8 |

We claim:

1. Polymeric material (I) comprising
a) a polymer (II) having amide groups recurring in the polymer main chain and
b) from 0.01 to 5% by weight, based on this polymer, of a titanium dioxide (III) having a median particle size d₅₀ of up to 150 nm.

2. Material (I) as claimed in claim 1, wherein said polymer (II) has a sterically hindered piperidine derivative (III) chemically attached to the ends of said polymer main chain.

3. Material (I) as claimed in claim 2, wherein said polymer (II) carries from 0.01 to 0.6 mol % of said piperidine derivative (III), based on acid amide groups of said polymer (II), at said ends of said polymer main chain.

4. Material (I) as claimed in any of claims 1 to 3, wherein said piperidine derivative (III) is 4-amino-2,2,6,6-tetramethylpiperidine.

5. Material (I) as claimed in any of claims 1 to 4, wherein said polymer (II) contains from 0.017 to 2.1% by weight, based on said polymer (II), of an organic dicarboxylic acid chain regulator.

6. Material (I) as claimed in any of claims 1 to 5, wherein said polymer (II) is polycaprolactam.

7. Material (I) as claimed in any of claims 1 to 6, wherein said polymer (II) is poly(hexamethylene diammonium adipate).

8. Material (I) as claimed in any of claims 1 to 7, further comprising at least 0.01% by weight, based on said polymer (II), of a titanium dioxide having a median particle size d₅₀ of at least 200 nm.

9. Fibers, sheet materials and moldings comprising a material (I) as set forth in any of claims 1 to 8.
